(19) United States
(12) Patent Application Publication
(10) Pub. No.: US 2016/0301611 A1
(43) Pub. Date: Oct. 13, 2016

(54) METHOD FOR AVOIDING CONGESTION ON NETWORK DEVICE AND NETWORK DEVICE

(71) Applicant: Huawei Technologies Co., Ltd., Shenzhen (CN)

(72) Inventors: Jin LI, Shenzhen (CN); Lei HAN, Shenzhen (CN); Hao WANG, Shenzhen (CN)

(21) Appl. No.: 15/179,638

(22) Filed: Jun. 10, 2016

Related U.S. Application Data
(63) Continuation of application No. PCT/CN2014/091343, filed on Nov. 18, 2014.

(30) Foreign Application Priority Data
Dec. 10, 2013 (CN) 201310665388.2

(51) Int. Cl. H04L 12/801; H04L 12/26; H04L 12/863; H04L 12/823

(52) U.S. Cl. CPC H04L 47/12; H04L 47/326; H04L 43/16; H04L 43/0882; H04L 43/0888; H04L 47/18; H04L 47/6255

(57) ABSTRACT

The present invention discloses a method for avoiding congestion on a network device and a network device, in order to resolve a problem of a decrease in a throughput of a network device caused when the network device performs, after receiving a series of packets, packet discarding processing on the series of packets in a manner of randomly and discretely discarding packets. The method includes: determining, by a network device according to a size of currently used storage space, whether packet discarding processing needs to be performed on packets that belong to a same data flow in the currently used storage space, where there are N packets that belong to the same data flow, and N≧2; and if packet discarding processing needs to be performed, discarding, by the network device, continuous M packets that belong to the same data flow, where 1≦M≦N.

### CROSS-REFERENCE TO RELATED APPLICATIONS

This application is a continuation of International Patent Application No. PCT/CN2014/091343, filed on Nov. 18, 2014, which claims priority to Chinese Patent Application No. 201310665388.2, filed on Dec. 10, 2013, both of which are hereby incorporated by reference in their entireties.

### TECHNICAL FIELD

The present invention relates to the communications field, and in particular, to a method for avoiding congestion on a network device and a network device.

### BACKGROUND

In a communications network, a network device receives a packet sent by a transmit end and forwards the packet to a receive end. However, when there are a relatively large quantity of packets sent by the transmit end, a case of congestion occurs on the network device. Congestion avoidance of a network device is performed by monitoring usage of storage space in the network device and proactively discarding some packets in the storage space when congestion tends to increase, so that a problem of congestion on the network device is resolved by adjusting data traffic in the network device.

In the prior art, a random early detection (RED) algorithm, a weighted random early detection (WRED) algorithm and the like are generally used to resolve the foregoing problem. Exemplarily, in an RED algorithm, a low limit and a high limit are set for a size of the foregoing storage space. If a size of currently used storage space is between the low limit and the high limit, incoming packets begin to be discarded randomly.

According to the foregoing algorithm, after receiving a series of packets sent by the transmit end, the network device performs packet discarding processing on the series of packets in a manner of randomly and discretely discarding packets. In this way, once one packet is discarded by the network device, the receive end notifies the transmit end that a packet discarding phenomenon occurs on the network device, and the transmit end determines that a congestion phenomenon currently occurs on the network device, thereby decreasing a quantity of packets to be sent. Accordingly, a quantity of packets that are forwarded by the network device is also decreased. If the network device discards a plurality of packets, a throughput of the network device is greatly decreased.

### SUMMARY

Embodiments of the present invention provide a method for avoiding congestion on a network device and a network device, in order to resolve a problem of a decrease in a throughput of a network device in the prior art caused when the network device performs, after receiving a series of packets, packet discarding processing on the series of packets in a manner of randomly and discretely discarding packets.

To achieve the foregoing objective, the following technical solutions are used in the embodiments of the present invention:

According to a first aspect, a method for avoiding congestion on a network device is provided, where the method includes:

determining, by a network device according to a size of currently used storage space, whether packet discarding processing needs to be performed on packets that belong to a same data flow in the currently used storage space, where there are N packets that belong to the same data flow, and N≧2; and

if packet discarding processing needs to be performed, discarding, by the network device, continuous M packets that belong to the same data flow, where 1≦M≦N.

According to a second aspect, a network device is provided, where the network device includes:

a determining module, configured to determine, according to a size of currently used storage space, whether packet discarding processing needs to be performed on packets that belong to a same data flow in the currently used storage space, where there are N packets that belong to the same data flow, and N≧2; and

a discarding module, configured to discard, if the determining module determines that packet discarding processing needs to be performed, continuous M packets that belong to the same data flow, where 1≦M≦N.

According to the method for avoiding congestion on a network device and a network device that are provided in the embodiments of the present invention, a network device determines, according to a size of currently used storage space, whether packet discarding processing needs to be performed on packets that belong to a same data flow, where there are N packets that belong to the same data flow, and N≧2; and if packet discarding processing needs to be performed, discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

### BRIEF DESCRIPTION OF DRAWINGS

To describe the technical solutions in the embodiments of the present invention more clearly, the following briefly describes the accompanying drawings required for describing the embodiments.

FIG. 1 is a schematic diagram of a method for avoiding congestion on a network device according to an embodiment of the present invention;

FIG. 2 is a schematic diagram of a function relationship between a size of used storage space and a first threshold in an embodiment of the present invention;

FIG. 3 is a schematic diagram of a function relationship between a size of used storage space and a second threshold in an embodiment of the present invention;

FIG. 4 is a schematic diagram of packets received by a network device when a length of a current storage queue is between a first limit and a second limit in an embodiment of the present invention;

FIG. 5 is a schematic diagram of a situation of TCP stream grouping of packets received by the network device when a length of a current storage queue is between a first limit and a second limit in Embodiment 1 of the present invention;

FIG. 6 is a schematic structural diagram of a network device according to an embodiment of the present invention; and

FIG. 7 is a schematic structural diagram of another network device according to an embodiment of the present invention.

### DESCRIPTION OF EMBODIMENTS

The following clearly describes the technical solutions in the embodiments of the present invention with reference to the accompanying drawings in the embodiments of the present invention.

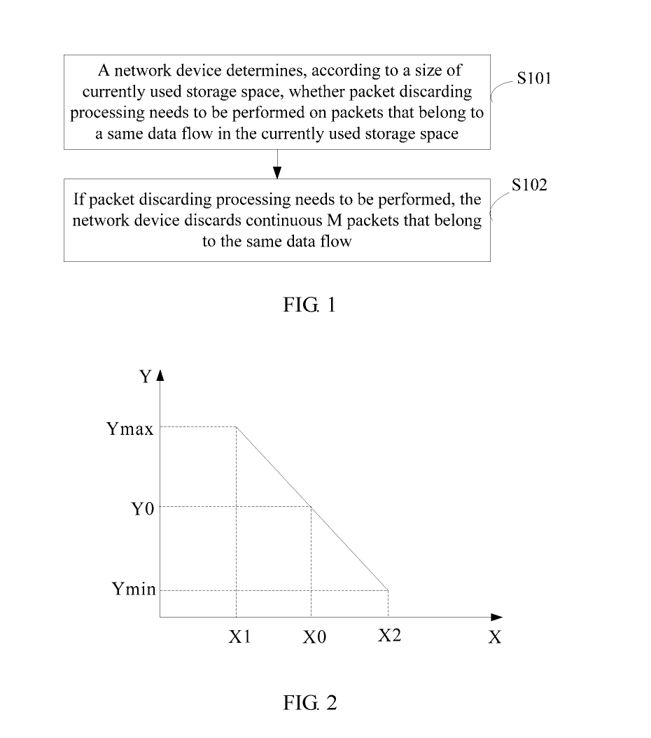

With reference to FIG. 1, a method for avoiding congestion on a network device according to an embodiment of the present invention includes the following steps:

S101. A network device determines, according to a size of currently used storage space, whether packet discarding processing needs to be performed on packets that belong to a same data flow in the currently used storage space.

There are N packets that belong to the same data flow, and N≧2.

In hardware resources of the network device, some hardware resources are used as storage space of the network device. When data is written in or read from the storage space, the size of the currently used storage space changes.

The size of the currently used storage space may be expressed by a quantity of bytes of the currently used storage space, and certainly, the size of the currently used storage space may also be expressed by a quantity of packets stored in the currently used storage space.

Exemplarily, assuming that there is no data in the current storage space, if 5 MB data is written in the storage space and no data is read from the storage space, the size of the currently used storage space is 5 MB; if 3 MB data is read from the foregoing storage space and no data is written in the storage space, the size of the currently used storage space changes from 5 MB to 2 MB.

Still exemplarily, assuming that there is no packet in the current storage space, if five packets are written in the storage space and no packet is read from the storage space, the size of the currently used storage space is five packets; if three packets are read from the foregoing storage space and no packet is written in the storage space, the size of the currently used storage space changes from five packets to two packets.

The belonging to a same data flow means that, if several packets are identical in at least one of a source Internet Protocol (IP) address, a destination IP address, a protocol number, a data flow source port, and a data flow destination port, the several packets belong to a same data flow.

In this step, packets stored in the currently used storage space may belong to a same data flow, or only N packets thereof belong to a same data flow.

Exemplarily, assuming that there are totally L (L≧N) packets stored in the currently used storage space, if L=N, the L packets stored in the currently used storage space belong to a same data flow; if L>N, only N packets in the L packets stored in the currently used storage space belong to a same data flow.

In this step, specifically, the network device may determine, in the following two manners, whether packet discarding processing needs to be performed on the packets that belong to the same data flow.

Manner 1:
(1) Acquire random numbers of the N packets that belong to the same data flow.

Preferably, a random number of a packet is a probability of randomly discarding the packet, and the probability of randomly discarding the packet is between 0 and 100%. Certainly, a random number of a packet may also be a number set by the network device for the packet, and the number may range from 0 to 100.
(2) Determine a current first threshold.

The first threshold is a critical value for determining whether packet discarding occurs in the data flow. The first threshold may be an empirical value, or may be a variable value.

Preferably, this step may specifically be: when the size of the currently used storage space is between a first limit and a second limit, the network device determines the current first threshold according to the size of the currently used storage space and a function relationship between a size of used storage space and a first threshold. In the function relationship between the size of the used storage space and the first threshold, one of the first limit and the second limit corresponds to a maximum first threshold, and the other thereof corresponds to a minimum first threshold.

In the function relationship between the size of the used storage space and the first threshold, the size of the used storage space may be positively correlated with the first threshold, or certainly, the size of the used storage space may be negatively correlated with the first threshold.

The positive correlation means that if a value of a variable is increased or decreased, a value of another variable is increased or decreased accordingly. The negative correlation means that if a value of a variable is increased or decreased, a value of another variable is decreased or increased accordingly.

That is, if the first limit corresponds to the maximum first threshold, and the second limit corresponds to the minimum first threshold, the size of the used storage space is negatively correlated with the first threshold in the function relationship between the size of the used storage space and the first threshold.

If the first limit corresponds to the minimum first threshold, and the second limit corresponds to the maximum first threshold, the size of the used storage space is positively correlated with the first threshold in the function relationship between the size of the used storage space and the first threshold.

Preferably, in this embodiment, in the function relationship between the size of the used storage space and the first threshold, the size of the used storage space is negatively correlated with the first threshold. In this case, exemplarily, for a schematic diagram of the function relationship between the size of the used storage space and the first threshold, reference may be made to FIG. 2.

In FIG. 2, an abscissa X represents a size of used storage space, an ordinate Y represents a first threshold, X1 represents a first limit, X2 represents a second limit, and X0 represents a size of currently used storage space; Ymax represents a maximum first threshold, Ymin represents a minimum first threshold, and Y0 represents a current first threshold, where the first limit X1 corresponds to the maximum first threshold Ymax, and the second limit X2 corresponds to the minimum first threshold Ymin.

Exemplarily, if a random number of a packet is a probability of randomly discarding the packet, the maximum first threshold Ymax may be 95%, and the minimum first threshold Ymin may be 5%.

Still exemplarily, if a random number of a packet is expressed by a number within a value range from 0 to 100, the maximum first threshold Ymax may be 95, and the minimum first threshold Ymin may be 5.

It should be noted that, the function relationship between the size of the used storage space and the first threshold in FIG. 2 is linear, which is only exemplary, or certainly, the function relationship may be nonlinear. No matter whether the function relationship is a linear relationship or a nonlinear relationship, in this embodiment, a slope of a curve Y-X is negative when the size of the currently used storage space X0 is between the first limit X1 and the second limit X2.
(3) Determine, according to the random numbers of the N packets and the current first threshold, whether packet discarding processing needs to be performed on the packets that belong to the same data flow.

In this step, if the current first threshold is a variable value, and the size of the used storage space is negatively correlated with the first threshold in the function relationship between the size of the used storage space and the first threshold, preferably, this step may specifically include the following:

If a sum of the random numbers of the N packets is less than the current first threshold, it is determined that packet discarding processing does not need to be performed on the packets that belong to the same data flow.

Further, in this case, it may be determined that the data flow to which the N packets belong is a small data flow.

In the prior art, each time when a network device discards a packet, a transmit end receives three acknowledgment (ACK) packets fed back by a receive end, so that the transmit end resends the discarded packet.

With regard to a small data flow, since there are a relatively low quantity of packets in the data flow (generally there are five to six packets), once the network device discards a packet located at a later location of the data flow, the transmit end fails to receive the three ACK packets fed back by the receive end, and the transmit end can resend the discarded packet only when a time for retransmitting packets that is preset by the transmit end expires, thereby resulting in an increase in a transmission time of the data flow. Therefore, in the present invention, to avoid a problem of an increase in a transmission time caused by packet discarding, with regard to a small data flow, the network device does not need to perform packet discarding processing on the data flow.

If the sum of the random numbers of the N packets is greater than the current first threshold, it is determined that packet discarding processing needs to be performed on the packets that belong to the same data flow.

Further, in this case, it may be determined that the data flow to which the N packets belong is a large data flow.

With regard to a large data flow, since there are a relatively large quantity of packets in the data flow, even if the network device discards a plurality of packets, relatively great impact is not caused on a transmission time of the data flow. Therefore, with regard to a large data flow, the network device may perform packet discarding processing on the data flow.

Further, when a same quantity of packets are discarded, if the network device uses a manner of randomly and discretely discarding packets in the prior art, each time when the network device discards a packet, a receive end notifies a transmit end that a packet discarding phenomenon occurs on the current network device, and then the transmit end determines that a congestion phenomenon occurs on the current network device, thereby decreasing a quantity of packets to be sent. Accordingly, a quantity of packets that are forwarded by the network device is also decreased. If the network device discards a plurality of packets, a throughput of the network device is greatly decreased.

In the present invention, since the network device performs packet discarding processing on the packets that belong to the same data flow, only when continuous packet discarding occurs on the network device once, the receive end notifies the transmit end that a packet discarding phenomenon occurs on the current network device. In this case, since a quantity of packets that are discarded is fixed, by using the method of the present invention, a quantity of times for determining, by the transmit end, that congestion phenomena occur on the current network device is decreased, and a quantity of times for decreasing a quantity of packets to be sent is decreased, thereby relieving a problem of a decrease in a throughput of the network device.

Manner 2:
(1) Acquire a random number of the data flow.

Preferably, a random number of a data flow is a probability of randomly discarding the data flow, and the probability of randomly discarding the data flow is between 0 and 100%. Certainly, a random number of a data flow may also be a number set by the network device for the data flow, and the number may range from 0 to 100.
(2) Determine a current second threshold.

The second threshold is a critical value for determining whether packet discarding occurs in the data flow. Similarly, the current second threshold may be an empirical value, or may be a variable value.

If the current second threshold is a variable value, in this case, preferably, when the size of the currently used storage space is between a first limit and a second limit, the network device may determine the current second threshold according to the size of the currently used storage space and a function relationship between a size of used storage space and a second threshold. In the function relationship between the size of the used storage space and the second threshold, one of the first limit and the second limit corresponds to a minimum second threshold, and the other thereof corresponds to a maximum second threshold.

In the function relationship between the size of the used storage space and the second threshold, the size of the used storage space may be positively correlated with the second threshold, or certainly, the size of the used storage space may be negatively correlated with the second threshold.

That is, if the first limit corresponds to the minimum second threshold, and the second limit corresponds to the maximum second threshold, the size of the used storage space is positively correlated with the second threshold in the function relationship between the size of the used storage space and the second threshold.

If the first limit corresponds to the maximum second threshold, and the second limit corresponds to the minimum second threshold, the size of the used storage space is negatively correlated with the second threshold in the function relationship between the size of the used storage space and the second threshold.

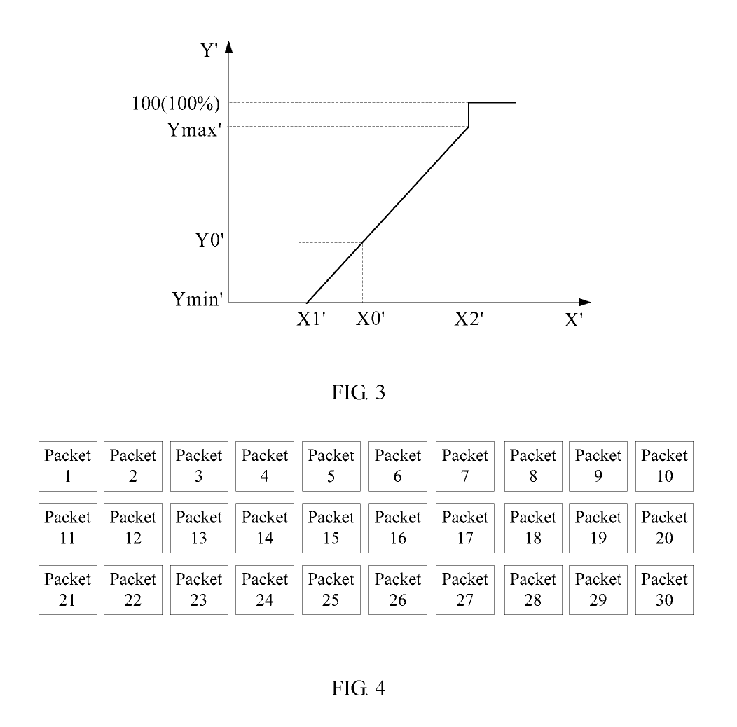

Preferably, in this embodiment, in the function relationship between the size of the used storage space and the second threshold, the size of the used storage space is positively correlated with the second threshold. In this case, exemplarily, for a schematic diagram of the function relationship between the size of the used storage space and the second threshold, reference may be made to FIG. 3.

In FIG. 3, an abscissa X′ represents a size of used storage space, an ordinate Y′ represents a second threshold, X1′ represents a first limit, X2′ represents a second limit, and X0′ represents a size of currently used storage space; Ymax′ represents a maximum second threshold, Ymin′ represent a minimum second threshold, and Y0′ represents a current second threshold; the first limit X1′ corresponds to the minimum second threshold Ymin′ and the second limit X2′ corresponds to the maximum second threshold Ymax′.

Exemplarily, if a random number of a data flow is a probability of randomly discarding the data flow, the maximum second threshold Ymax′ may be 95%, and the minimum second threshold Ymin′ may be 0.

Still exemplarily, if a random number of a data flow is expressed by a number within a value range from 0 to 100, the maximum second threshold Ymax′ may be 95, and the minimum second threshold Ymin′ may be 0.

Similarly, it should be noted that, the function relationship between the size of the used storage space and the second threshold in FIG. 3 is linear, which is only exemplary, or certainly, the function relationship may be nonlinear. No matter whether the function relationship is a linear relationship or a nonlinear relationship, in this embodiment, a slope of a curve Y′-X′ is positive when the size of the currently used storage space X0′ is between the first limit X1′ and the second limit X2′.
(3) Determine, according to the random number of the data flow and the current second threshold, whether packet discarding processing needs to be performed on the packets in the.

In this step, if the current second threshold is a variable value, and the size of the used storage space is positively correlated with the second threshold in the function relationship between the size of the used storage space and the second threshold, preferably, this step may specifically include the following:

If the random number of the data flow is less than the current second threshold, it is determined that packet discarding processing needs to be performed on the packets in the data flow.

In this case, it may be determined that the data flow is a large data flow.

If the random number of the data flow is greater than the current second threshold, it is determined that packet discarding processing does not need to be performed on the packets in the data flow.

In this case, it may be determined that the data flow is a small data flow.

It should be noted that, when the size of the currently used storage space is between a first limit and a second limit, the network device may determine whether packet discarding processing needs to be performed on the packets that belong to the same data flow in the currently used storage space; certainly, other manners may also be used.

Preferably, when the size of the currently used storage space is between the first limit and the second limit, the network device determines whether packet discarding processing needs to be performed on the packets that belong to the same data flow in the currently used storage space.

In this case, if the first limit is zero, and the second limit is a fixed value that is less than or equal to a capacity of storage space of the network device, the network device only needs to determine, when the size of the currently used storage space is less than the second limit, whether packet discarding processing needs to be performed on the packets that belong to the same data flow in the currently used storage space.

If the first limit is a nonzero fixed value, and the second limit is a fixed value that is less than or equal to a capacity of storage space of the network device, the network device only need to determine, when the size of the currently used storage space is greater than the first limit and less than the second limit, whether packet discarding processing needs to be performed on the packets that belong to the same data flow in the currently used storage space.

S102. if packet discarding processing needs to be performed, the network device discards continuous M packets that belong to the same data flow, where 1≦M≦N.

In this step, preferably, the data flow is a Transmission Control Protocol (TCP) stream. In this case, this step may specifically be: if packet discarding processing needs to be performed, the network device discards continuous M packets that have continuous TCP serial numbers and that belong to the same TCP stream. In this case, M is positively correlated with the number N of packets that belong to the same TCP stream.

The TCP serial number refers to a sequence number of a packet in a TCP stream. The M packets that have continuous TCP serial numbers refer to M packets that have continuous sequence numbers in a TCP stream.

Exemplarily, assuming that M=3, if a TCP serial number of the first packet is 10235486, a TCP serial number of the second packet is 10235487, and a TCP serial number of the third packet is 10235488, the three packets are continuous.

Herein, that M is positively correlated with the number N of packets that belong to the same TCP stream means that, if the number N of packets that belong to the same TCP stream increases or decreases, the number M of packets that are discarded increases or decreases accordingly.

In the method for avoiding congestion on a network device according to this embodiment of the present invention, a network device determines, according to a size of currently used storage space, whether packet discarding processing needs to be performed on packets that belong to a same data flow, where there are N packets that belong to the same data flow, and N≧2; and if packet discarding processing needs to be performed, discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

The method for avoiding congestion on a network device according to this embodiment of the present invention is described below in detail with reference to transmission scenarios of specific TCP streams.

In all embodiments of the present invention, used storage space of the network device may be expressed by a storage queue of the network device. Further, a length of the storage queue is expressed by a quantity of packets stored in the storage queue.

Referring to a schematic diagram of packets stored in a current storage queue shown in FIG. 4, it may be known that a length of a currently used storage queue of the network device is 30, that is, 30 packets are stored in the currently used storage queue, and the 30 packets are named a packet 1, a packet 2, . . . , and a packet 30 in sequence. Further, it is assumed that a first limit is 20, a second limit is 120, and a capacity of storage queue of the network device is 150.

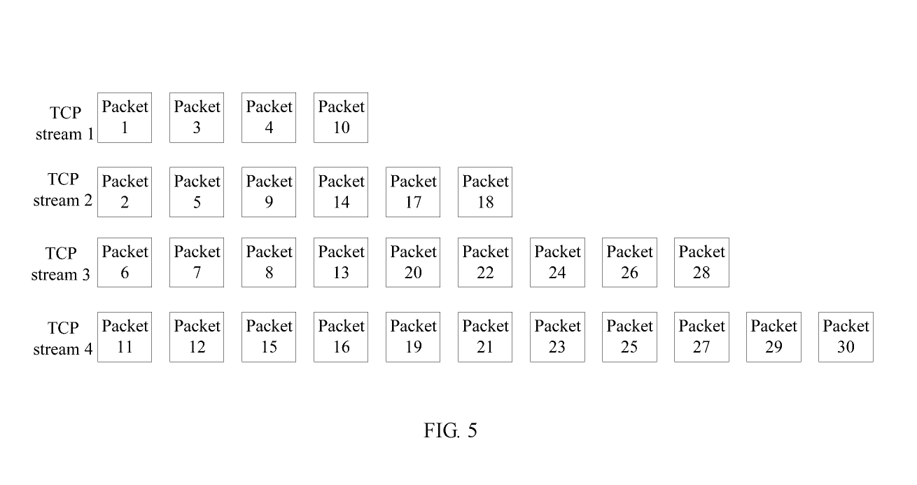

Referring to FIG. 5, in this case, the network device may determine, according to a difference in source IP addresses, destination IP addresses, protocol numbers, data flow source ports, or data flow destination ports of 30 packets stored in a current storage queue, that a packet 1, a packet 3, a packet 4, and a packet 10 belong to a TCP stream 1, a packet 2, a packet 5, a packet 9, a packet 14, a packet 17, and a packet 18 packet belong to a TCP stream 2, a packet 6, a packet 7, a packet 8, a packet 13, a packet 20, a packet 22, a packet 24, a packet 26, and a packet 28 belong to a TCP stream 3, and a packet 11, a packet 12, a packet 15, a packet 16, a packet 19, a packet 21, a packet 23, a packet 25, a packet 27, a packet 29, and a packet 30 belong to a TCP stream 4.

### Embodiment 1

A method for avoiding congestion on a network device according to this embodiment includes the following steps:

Step 1. When a length of a currently used storage queue is between a first limit 20 and a second limit 120, a network device determines whether packet discarding processing needs to be performed on packets that belong to a same data flow in the currently used storage queue.

This step specifically includes the following:
(1) Acquire random numbers of packets in the foregoing four TCP streams.

Exemplarily, in this case, the random numbers of the packets in the foregoing four TCP streams are probabilities of randomly discarding the packets in the foregoing four TCP streams. Further, it is assumed that probabilities of randomly discarding the foregoing 30 packets are ai, where i represents a sequence number of a packet, and 1≦i≦30; and ai represents a probability of randomly discarding the i^{th} packet, and 0≦ai≦1.
(2) Determine a current first threshold.

Exemplarily, the current first threshold is a discarding probability currently set for the data flow, which may be called a first discarding probability in this embodiment.

In this case, referring to FIG. 2, it is assumed that a function relation of a length of a used storage queue and a first threshold is:

$$Y = \{ \begin{matrix}0.95 & 0 \leq X < 20 \\ - 0.009 X + 1.13 & 20 \leq X < 120 \\ 0 & 120 \leq X < 150\end{matrix} .$$

Since X1=20, X2=120, and X0=30, it may be determined that a current first discarding probability is 86%.
(3) Determine, according to the random numbers of the 30 packets and the current first threshold, whether packet discarding processing needs to be performed on the packets in the four TCP streams.

Exemplarily, assuming that a sum of probabilities of randomly discarding all packets in the TCP stream 1 Σai (i=1, 3, 4, 10)<86%, it is determined that packet discarding processing does not need to be performed on four packets in the TCP stream 1.

In this case, the network device does not perform step 2.

Still exemplarily, assuming that a sum of probabilities of randomly discarding all packets in the TCP stream 2 Σai (i=2, 5, 9, 14, 17, and 18)<86%, it is determined that packet discarding processing does not need to be performed on six packets in the TCP stream 2.

In this case, the network device does not perform step 2.

Still exemplarily, assuming that a sum of probabilities of randomly discarding all packets in the TCP stream 3 Σai (i=6, 7, 8, 13, 20, 22, 24, 26, 28)>86%, it is determined that packet discarding processing needs to be performed on nine packets in the TCP stream 3.

In this case, the network device continues to perform step 2.

Still exemplarily, assuming that a sum of probabilities of randomly discarding all packets in the TCP stream 4 Σai (i=11, 12, 15, 16, 19, 21, 23, 25, 27, 29, and 30)>86%, it is determined that packet discarding processing needs to be performed on 11 packets in the TCP stream 4.

In this case, the network device continues to perform step 2.

Step 2. The network device discards continuous M1 packets in the TCP stream 3; the network device discards continuous M2 packets in the TCP stream 4, where 1≦M1≦9, and 1≦M2≦11.

Exemplarily, the network device discards two packets (the packet 6 and the packet 7) in the TCP stream 3, where TCP serial numbers of the packet 6 and the packet 7 are continuous.

Still exemplarily, the network device discards four packets (the packet 25, the packet 27, the packet 29, and the packet 30) in the TCP stream 4, where TCP serial numbers of the packet 25, the packet 27, the packet 29, and the packet 30 are continuous.

In the method for avoiding congestion on a network device according to this embodiment of the present invention, a network device determines, according to a size of currently used storage space, whether packet discarding processing needs to be performed on packets that belong to a same data flow, where there are N packets that belong to the same data flow, and N≦2; and if packet discarding processing needs to be performed, discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

### Embodiment 2

In this embodiment, if a length of a current storage queue is between a first limit 20 and a second limit 120, the network device determines, in another manner, whether packet discarding processing needs to be performed on the packets in the foregoing four TCP streams. In this embodiment, only a difference from Embodiment 1 is listed. For other parts, reference may be made to the description in Embodiment 1, and details are not described herein again.

Specifically, an alternative step of step 1 of Embodiment 1 may be as follows:

Step 1. When a length of a currently used storage queue is between a first limit 20 and a second limit 120, a network device determines whether packet discarding processing needs to be performed on packets that belong to a same data flow in the currently used storage queue.

This step specifically includes the following:
(1) Acquire random numbers of the foregoing four TCP streams.

Exemplarily, in this case, the random numbers of the foregoing four TCP streams are probabilities of randomly discarding the foregoing four TCP streams. Further, it is assumed that the probabilities of randomly discarding the foregoing four TCP streams are bi, where i represents a sequence number of a TCP stream, and 1≦i≦4; and bi represents a probability of randomly discarding the i^{th} TCP stream, and 0≦bi≦1.
(2) Determine a current second threshold.

Exemplarily, the current second threshold is a discarding probability currently set for the data flow, which may be called a second discarding probability in this embodiment.

In this case, referring to FIG. 3, it is assumed that a function relation of a length of a used storage queue and a second threshold is:

$${Y}^{′} = \{ \begin{matrix}0 & 0 \leq {X}^{′} < 20 \\ - 0.0095 {X}^{′} + 0.19 & 20 \leq {X}^{′} < 120 \\ 1 & 120 \leq {X}^{′} < 150\end{matrix} .$$

Since X1′=20, X2′=120, and X0′=30, it may be determined that a current second discarding probability is 9.5%.
(3) Determine, according to the random numbers of the foregoing four TCP streams and the current second threshold, whether packet discarding processing needs to be performed on the packets in the four TCP streams.

Exemplarily, assuming that a probability of randomly discarding the TCP stream 1 b1>9.5%, it is determined that packet discarding processing does not need to be performed on four packets in the TCP stream 1.

Still exemplarily, assuming that a probability of randomly discarding the TCP stream 2 b2>9.5%, it is determined that packet discarding processing does not need to be performed on six packets in the TCP stream 2.

Still exemplarily, assuming that a probability of randomly discarding the TCP stream 3 b3<9.5%, it is determined that packet discarding processing needs to be performed on nine packets in the TCP stream 3.

Still exemplarily, assuming that a probability of randomly discarding the TCP stream 4 b4<9.5%, it is determined that packet discarding processing needs to be performed on 11 packets in the TCP stream 4.

In the method for avoiding congestion on a network device according to this embodiment of the present invention, a network device determines, according to a size of currently used storage space, whether packet discarding processing needs to be performed on packets that belong to a same data flow, where there are N packets that belong to the same data flow, and N≧2; and if packet discarding processing needs to be performed, discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

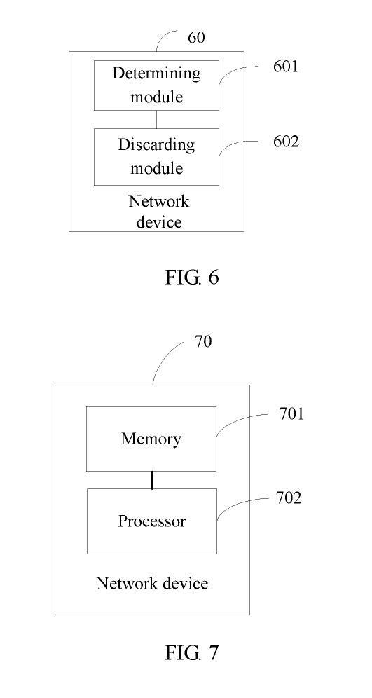

Referring to FIG. 6, an embodiment of the present invention provides a network device 60, where the network device 60 includes:

a determining module 601, configured to determine, according to a size of currently used storage space, whether packet discarding processing needs to be performed on packets that belong to a same data flow in the currently used storage space, where there are N packets that belong to the same data flow, and N≧2; and

a discarding module 602, configured to discard, if the determining module 601 determines that packet discarding processing needs to be performed, continuous M packets that belong to the same data flow, where 1≦M≦N.

Optionally, the determining module 601 includes:

a first acquiring unit, configured to acquire random numbers of the N packets that belong to the same data flow;

a first determining unit, configured to determine a current first threshold, where the first threshold is a critical value for determining whether packet discarding occurs in the data flow; and

a second determining unit, configured to determine, according to the random numbers of the N packets acquired by the first acquiring unit and the current first threshold determined by the first determining unit, whether packet discarding processing needs to be performed on the packets that belong to the same data flow in the currently used storage space.

Optionally, the determining module 601 is configured to: when the size of the currently used storage space is between a first limit and a second limit, determine whether packet discarding processing needs to be performed on the packets that belong to the same data flow in the currently used storage space, where the first limit is less than the second limit, and the second limit is less than or equal to a capacity of storage space of the network device.

The first determining unit is configured to determine the current first threshold according to the size of the currently used storage space and a function relationship between a size of used storage space and a first threshold, where in the function relationship between the size of the used storage space and the first threshold, one of the first limit and the second limit corresponds to a maximum first threshold, and the other thereof corresponds to a minimum first threshold.

Optionally, in the function relationship between the size of the used storage space and the first threshold, the size of the used storage space is negatively correlated with the first threshold.

The second determining unit is configured to: if a sum of the random numbers of the N packets is less than the current first threshold, determine that packet discarding processing does not need to be performed on the packets that belong to the same data flow; and if the sum of the random numbers of the N packets is greater than the current first threshold, determine that packet discarding processing needs to be performed on the packets that belong to the same data flow.

Optionally, the determining module 601 includes:

a second acquiring unit, configured to acquire a random number of the data flow;

a third determining unit, configured to determine a current second threshold, where the second threshold is a critical value for determining whether packet discarding occurs in a data flow; and

a fourth determining unit, configured to determine, according to the random number of the data flow acquired by the second acquiring unit and the current second threshold determined by the third determining unit, whether packet discarding processing needs to be performed on the packets in the data flow.

Optionally, the determining module 601 is configured to: when the size of the currently used storage space is between a first limit and a second limit, determine whether packet discarding processing needs to be performed on the packets that belong to the same data flow in the currently used storage space, where the first limit is less than the second limit, and the second limit is less than or equal to a capacity of storage space of the network device.

The third determining unit is configured to determine the current second threshold according to the size of the currently used storage space and a function relationship between a size of used storage space and a second threshold, where in the function relationship between the size of the used storage space and the second threshold, one of the first limit and the second limit corresponds to a minimum second threshold, and the other thereof corresponds to a maximum second threshold.

Optionally, in the function relationship between the size of the used storage space and the second threshold, the size of the used storage space is positively correlated with the second threshold.

The fourth determining unit is configured to: if the random number of the data flow is less than the current second threshold, determine that packet discarding processing needs to be performed on the packets in the data flow; and if the random number of the data flow is greater than the current second threshold, determine that packet discarding processing does not need to be performed on the packets in the data flow.

Optionally, the data flow is a TCP stream.

The discarding continuous M packets that belong to the same data flow includes: discarding M packets that have continuous TCP serial numbers and that belong to the same TCP stream.

According to the network device 60 provided in this embodiment of the present invention, a determining module 601 determines, according to a size of currently used storage space, whether packet discarding processing needs to be performed on packets that belong to a same data flow, where there are N packets that belong to the same data flow, and N≧2; and if packet discarding processing needs to be performed, a discarding module 602 discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

Referring to FIG. 7, an embodiment of the present invention further provides a network device 70, where the network device 70 includes: a memory 701 and a processor 702 connected to the memory 701.

The memory 701 is configured to store a received packet.

The processor 702 is configured to determine, according to a size of currently used storage space in the memory 701, whether packet discarding processing needs to be performed on packets that belong to a same data flow in the currently used storage space, where there are N packets that belong to the same data flow, and N≧2.

The processor 702 is further configured to discard, if packet discarding processing needs to be performed, continuous M packets that belong to the same data flow, where 1≦M≦N.

Optionally, the processor 702 is specifically configured to acquire random numbers of the N packets that belong to the same data flow; determine a current first threshold; determine, according to the random numbers of the N packets and the current first threshold, whether packet discarding processing needs to be performed on the packets that belong to the same data flow in the currently used storage space, where the first threshold is a critical value for determining whether packet discarding occurs in the data flow.

Optionally, the processor 702 is specifically configured to: when the size of the currently used storage space is between a first limit and a second limit, determine whether packet discarding processing needs to be performed on the packets that belong to the same data flow in the currently used storage space, where the first limit is less than the second limit, and the second limit is less than or equal to a capacity of storage space of the network device.

The processor 702 is specifically configured to determine the current first threshold according to the size of the currently used storage space and a function relationship between a size of used storage space and a first threshold, where in the function relationship between the size of the used storage space and the first threshold, one of the first limit and the second limit corresponds to a maximum first threshold, and the other thereof corresponds to a minimum first threshold.

Optionally, in the function relationship between the size of the used storage space and the first threshold, the size of the used storage space is negatively correlated with the first threshold.

The processor 702 is specifically configured to: if a sum of the random numbers of the N packets is less than the current first threshold, determine that packet discarding processing does not need to be performed on the packets that belong to the same data flow; and if the sum of the random numbers of the N packets is greater than the current first threshold, determine that packet discarding processing needs to be performed on the packets that belong to the same data flow.

Optionally, the processor 702 is specifically configured to acquire a random number of the data flow; determine a current second threshold; determine, according to the random number of the data flow and the current second threshold, whether packet discarding processing needs to be performed on the packets in the data flow, where the second threshold is a critical value for determining whether packet discarding occurs in the data flow.

Optionally, the processor 702 is specifically configured to: when the size of the currently used storage space is between a first limit and a second limit, determine whether packet discarding processing needs to be performed on the packets that belong to the same data flow in the currently used storage space, where the first limit is less than the second limit, and the second limit is less than or equal to a capacity of storage space of the network device.

The processor 702 is specifically configured to determine the current second threshold according to the size of the currently used storage space and a function relationship between a size of used storage space and a second threshold, where in the function relationship between the size of the used storage space and the second threshold, one of the first limit and the second limit corresponds to a minimum second threshold, and the other thereof corresponds to a maximum second threshold.

Optionally, in the function relationship between the size of the used storage space and the second threshold, the size of the used storage space is positively correlated with the second threshold.

The processor 702 is specifically configured to: if the random number of the data flow is less than the current second threshold, determine that packet discarding processing needs to be performed on the packets in the data flow; and if the random number of the data flow is greater than the current second threshold, determine that packet discarding processing does not need to be performed on the packets in the data flow.

Optionally, the data flow is a TCP stream.

The discarding continuous M packets that belong to the same data flow includes: discarding M packets that have continuous TCP serial numbers and that belong to the same TCP stream.

According to the network device 70 provided in this embodiment of the present invention, a processor 702 determines, according to a size of currently used storage space in a memory 701, whether packet discarding processing needs to be performed on packets that belong to a same data flow, where there are N packets that belong to the same data flow, and N≧2; and if packet discarding processing needs to be performed, discards continuous M packets that belong to the same data flow, where 1≦M≦N. Only each time continuous packet discarding occurs when the network device performs packet discarding processing on the packets that belong to the same data flow, a receive end notifies a transmit end that a packet discarding phenomenon occurs. In this case, a quantity of times for determining, by the transmit end, that congestion phenomena occur on the current network device is decreased, and a quantity of times for decreasing a quantity of packets to be sent is also decreased, thereby relieving a problem of a decrease in a throughput of a network device in the prior art caused when the network device performs, after receiving a series of packets, packet discarding processing on the series of packets in a manner of randomly and discretely discarding packets.

In the several embodiments provided in the present application, it should be understood that, the disclosed system, device, and method may be implemented in other manners. For example, the apparatus embodiments described above are merely exemplary. For example, the unit division is merely logic function division and may be other division in actual implementation. For example, a plurality of units or components may be combined or integrated to another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be separated physically, and parts displayed as units may or may not be physical units, may be located in one position, or may be distributed on a plurality of network units. Some or all of the units may be selected to according to actual needs to achieve the objectives of the solutions of the embodiments.

In addition, functional units in the embodiments of the present invention may be integrated into one processing unit, or each of the units may exist alone physically, or two or more units may be integrated into one unit. The foregoing integrated unit may be implemented in a hardware form, or may be implemented in a form of hardware and software functional units.

The foregoing integrated unit implemented in a form of a software functional unit may be stored in a computer-readable storage medium. The foregoing software functional unit is stored in a storage medium and includes several instructions for instructing a computer device (which may be a personnel computer, a server, a network device, or the like) to execute some of the steps of the methods in the embodiments of the present invention. The foregoing storage medium includes various kinds of media that can store program code, such as a USB flash drive, a removable hard disk, a read-only memory (ROM), a random access memory (RAM), a magnetic disk, or an optical disc.

Finally, it should be noted that, the foregoing embodiments are merely intended for describing the technical solutions of the present invention, but not for limiting the present invention. Although the present invention has been described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A method for avoiding congestion on a network device, comprising:
determining, by a network device according to a size of currently used storage space, whether packet discarding processing needs to be performed on packets that belong to a same data flow in the currently used storage space, wherein there are N packets that belong to the same data flow, and N≧2; and
if packet discarding processing needs to be performed, discarding, by the network device, continuous M packets that belong to the same data flow, wherein 1≦M≦N.

2. The method according to claim 1, wherein the determining whether packet discarding processing needs to be performed on packets that belong to a same data flow in the currently used storage space comprises:
acquiring random numbers of the N packets that belong to the same data flow;
determining a current first threshold, wherein the first current threshold is a critical value for determining whether packet discarding occurs in the data flow; and
determining, according to the random numbers of the N packets and the current first threshold, whether packet discarding processing needs to be performed on the packets that belong to the same data flow in the currently used storage space.

3. The method according to claim 2, wherein the determining, by a network device according to a size of currently used storage space, whether packet discarding processing needs to be performed on packets that belong to a same data flow in the currently used storage space comprises:
when the size of the currently used storage space is between a first limit and a second limit, determining, by the network device, whether packet discarding processing needs to be performed on the packets that belong to the same data flow in the currently used storage space, wherein the first limit is less than the second limit, and the second limit is less than or equal to a capacity of storage space of the network device; and
the determining a current first threshold comprises:
determining the current first threshold according to the size of the currently used storage space and a function relationship between a size of used storage space and a first threshold, wherein in the function relationship between the size of the used storage space and the first threshold, one of the first limit and the second limit corresponds to a maximum first threshold, and the other thereof corresponds to a minimum first threshold.

4. The method according to claim 3, wherein in the function relationship between the size of the used storage space and the first threshold, the size of the used storage space is negatively correlated with the first threshold; and
the determining, according to the random numbers of the N packets and the current first threshold, whether packet discarding processing needs to be performed on the packets that belong to the same data flow comprises:
if a sum of the random numbers of the N packets is less than the current first threshold, determining that packet discarding processing does not need to be performed on the packets that belong to the same data flow; and
if the sum of the random numbers of the N packets is greater than the current first threshold, determining that packet discarding processing needs to be performed on the packets that belong to the same data flow.

5. The method according to claim 1, wherein the determining whether packet discarding processing needs to be performed on packets that belong to a same data flow in the currently used storage space comprises:
acquiring a random number of the data flow;
determining a current second threshold, wherein the current second threshold is a critical value for determining whether packet discarding occurs in the data flow; and
determining, according to the random number of the data flow and the current second threshold, whether packet discarding processing needs to be performed on the packets in the data flow.

6. The method according to claim 5, wherein the determining, by a network device according to a size of currently used storage space, whether packet discarding processing needs to be performed on packets that belong to a same data flow in the currently used storage space comprises:
when the size of the currently used storage space is between a first limit and a second limit, determining, by the network device, whether packet discarding processing needs to be performed on the packets that belong to the same data flow in the currently used storage space, wherein the first limit is less than the second limit, and the second limit is less than or equal to a capacity of storage space of the network device; and
the determining a current second threshold comprises:
determining the current second threshold according to the size of the currently used storage space and a function relationship between a size of used storage space and a second threshold, wherein in the function relationship between the size of the used storage space and the second threshold, one of the first limit and the second limit corresponds to a minimum second threshold, and the other thereof corresponds to a maximum second threshold.

7. The method according to claim 6, wherein in the function relationship between the size of the used storage space and the second threshold, the size of the used storage space is positively correlated with the second threshold; and
the determining, according to the random number of the data flow and the current second threshold, whether packet discarding processing needs to be performed on the packets in the data flow comprises:
if the random number of the data flow is less than the current second threshold, determining that packet discarding processing needs to be performed on the packets in the data flow; and
if the random number of the data flow is greater than the current second threshold, determining that packet discarding processing does not need to be performed on the packets in the data flow.

8. The method according to claim 1, wherein the data flow is a TCP stream; and
the discarding continuous M packets that belong to the same data flow comprises: discarding M packets that have continuous TCP serial numbers and that belong to the same TCP stream.

9. A network device, comprising:
a determining module, configured to determine, according to a size of currently used storage space, whether packet discarding processing needs to be performed on packets that belong to a same data flow in the currently used storage space, wherein there are N packets that belong to the same data flow, and N≧2; and
a discarding module, configured to discard, if the determining module determines that packet discarding processing needs to be performed, continuous M packets that belong to the same data flow, wherein 1≦M≦N.

10. The network device according to claim 9, wherein the determining module comprises:
a first acquiring unit, configured to acquire random numbers of the N packets that belong to the same data flow;
a first determining unit, configured to determine a current first threshold, wherein the current first threshold is a critical value for determining whether packet discarding occurs in the data flow; and
a second determining unit, configured to determine, according to the random numbers of the N packets acquired by the first acquiring unit and the current first threshold determined by the first determining unit, whether packet discarding processing needs to be performed on the packets that belong to the same data flow in the currently used storage space.

11. The network device according to claim 10, wherein the determining module is configured to: when the size of the currently used storage space is between a first limit and a second limit, determine whether packet discarding processing needs to be performed on the packets that belong to the same data flow in the currently used storage space, wherein the first limit is less than the second limit, and the second limit is less than or equal to a capacity of storage space of the network device; and
the first determining unit is configured to determine the current first threshold according to the size of the currently used storage space and a function relationship between a size of used storage space and a first threshold, wherein in the function relationship between the size of the used storage space and the first threshold, one of the first limit and the second limit corresponds to a maximum first threshold, and the other thereof corresponds to a minimum first threshold.

12. The network device according to claim 11, wherein in the function relationship between the size of the used storage space and the first threshold, the size of the used storage space is negatively correlated with the first threshold; and
the second determining unit is configured to: if a sum of the random numbers of the N packets is less than the current first threshold, determine that packet discarding processing does not need to be performed on the packets that belong to the same data flow; and if the sum of the random numbers of the N packets is greater than the current first threshold, determine that packet discarding processing needs to be performed on the packets that belong to the same data flow.

13. The network device according to claim 9, wherein the determining module comprises:
a second acquiring unit, configured to acquire a random number of the data flow;
a third determining unit, configured to determine a current second threshold, wherein the current second threshold is a critical value for determining whether packet discarding occurs in the data flow; and
a fourth determining unit, configured to determine, according to the random number of the data flow acquired by the second acquiring unit and the current second threshold determined by the third determining unit, whether packet discarding processing needs to be performed on the packets in the data flow.

14. The network device according to claim 13, wherein the determining module is configured to: when the size of the currently used storage space is between a first limit and a second limit, determine whether packet discarding processing needs to be performed on the packets that belong to the same data flow in the currently used storage space, wherein the first limit is less than the second limit, and the second limit is less than or equal to a capacity of storage space of the network device; and
the third determining unit is configured to determine the current second threshold according to the size of the currently used storage space and a function relationship between a size of used storage space and a second threshold, wherein in the function relationship between the size of the used storage space and the second threshold, one of the first limit and the second limit corresponds to a minimum second threshold, and the other thereof corresponds to a maximum second threshold.

15. The network device according to claim 14, wherein in the function relationship between the size of the used storage space and the second threshold, the size of the used storage space is positively correlated with the second threshold; and
the fourth determining unit is configured to: if the random number of the data flow is less than the current second threshold, determine that packet discarding processing needs to be performed on the packets in the data flow; and if the random number of the data flow is greater than the current second threshold, determine that packet discarding processing does not need to be performed on the packets in the data flow.
